(19) United States
(12) Patent Application Publication
(10) Pub. No.: US 2018/0139525 A1
(43) Pub. Date: May 17, 2018

(54) EAR MUFF

(71) Applicant: SHENZHEN ROYOLE TECHNOLOGIES CO., LTD., Shenzhen, Guangdong (CN)

(72) Inventors: Songya Chen, Shenzhen, Guangdong (CN); Songling Yang, Shenzhen, Guangdong (CN); Zihong Liu, Shenzhen, Guangdong (CN)

(21) Appl. No.: 15/572,689

(22) PCT Filed: Jul. 7, 2015
(86) PCT No.: PCT/CN2015/083422

§ 371 Date: Nov. 8, 2017

(51) Int. Cl. H04R 1/10

(52) U.S. Cl. CPC H04R 1/1008

(57) ABSTRACT

An ear muff is provided. The ear muff includes a gasket, a covering piece and a soft cushion. The gasket has a mounting surface with two side edges opposite to each other. The covering piece includes a plurality of mounting portions and a plurality of spacing portions. Each mounting portion and each spacing portion are arranged alternatively. The plurality of mounting portions is fixed to any of the two side edges and the plurality of spacing portions is separable from the any of the side edges fixing the plurality of mounting portions. The soft cushion is covered in the covering piece.

### CROSS REFERENCE TO RELATED APPLICATION

The present application is a U.S. National Phase application under 35 U.S.C. §371 of International Patent Application No. PCT/CN2015/083422, filed on Jul. 7, 2015, published as WO 2017/004784 on Jan. 12, 2017, not in English, the entire contents of which are incorporated by reference as part of the disclosure of this U.S. application.

### FIELD

The present disclosure relates to an ear muff, and especially to an ear muff convenient for inner ventilation.

### BACKGROUND

User can experience a good sound effect when wearing a headset, as the headset can cover the whole ears, and thus the headset is popular. It is an ear muff of the headset provided at a periphery of a loudspeaker that covers the ears. The ear muff usually includes foam and man-made feather covering the foam. A foam-type headset is compressed in a wearing state and requires to return to an original state when taken down, and thus the headset needs to be in an environment having a good air permeability. The ear muff in the related art is usually provided with a plurality of through holes in an inner surface of the man-made feather, i.e. the surface facing the ears of the user, so as to enable the airflow to get in and out of the man-made feather. In this manner, it is required to perforate the man-made feather, so a rejection rate of the man-made feather increases inevitably.

### SUMMARY

The present disclosure provides an ear muff convenient for inner ventilation and having a high product yield rate.

An embodiment of the present disclosure provides an ear muff, including: a gasket, the gasket including a mounting surface with two side edges opposite to each other; a covering piece, the covering piece including a plurality of mounting portions and a plurality of spacing portions, each mounting portion and each spacing portion being arranged alternatively, the plurality of mounting portions being fixed to any of the two side edges and the plurality of spacing portions being separable from the any of the two side edges fixing the plurality of mounting portions; and a soft cushion, the soft cushion being covered in the covering piece.

In a deformation process of the soft cushion, air can get in and out of the covering piece through the spacing portions unfixed to the mounting surface, so as to facilitate the deformation of the soft cushion. Thus, it is not required to perforate the covering piece, thereby reducing a rejection rate of the covering piece.

### BRIEF DESCRIPTION OF THE DRAWINGS

The following accompanying drawings are used for illustrating various embodiments of the present disclosure in detail in combination with specific embodiments. It should be understood that various elements illustrated in the accompanying drawings do not represent actual sizes and scale relations, and the accompanying drawings are only schematic views intended for clear illustration.

Thus, the accompanying drawings should not be construed to limit the present disclosure.

FIG. 1 is a schematic view of an ear muff according to a first embodiment of the present disclosure.

FIG. 2 is a sectional view of the ear muff in FIG. 1.

FIG. 3 is an enlarged view of part III circled by a dashed line in FIG. 2.

FIG. 4 is a schematic view of an alternative embodiment similar to FIG. 3.

FIG. 5 is a sectional view of an ear muff according to a second embodiment of the present disclosure.

FIG. 6 is an enlarged view of part VI circled by a dashed line in FIG. 5.

FIG. 7 is a schematic view of an alternative embodiment similar to FIG. 6.

FIG. 8 is a partial side view of an ear muff according to a third embodiment of the present disclosure, and a direction of the side view refers to cutting plane line X-X in FIG. 3.

FIG. 9 is a schematic view of an alternative embodiment similar to FIG. 8, and a direction of the sectional view refers to cutting plane line Y-Y in FIG. 6.

### DETAILED DESCRIPTION

In order to make the objectives, technical solutions and advantages of the present disclosure more definite and clear, the present disclosure is further illustrated in detail in combination with a plurality of embodiments and accompanying drawings. It should be understood that, the specific embodiments described herein are only used for explaining the present disclosure and not for limiting the present disclosure. In addition, what illustrated in the accompanying drawings does not represent actual scale relations of various elements and is only used for illustration.

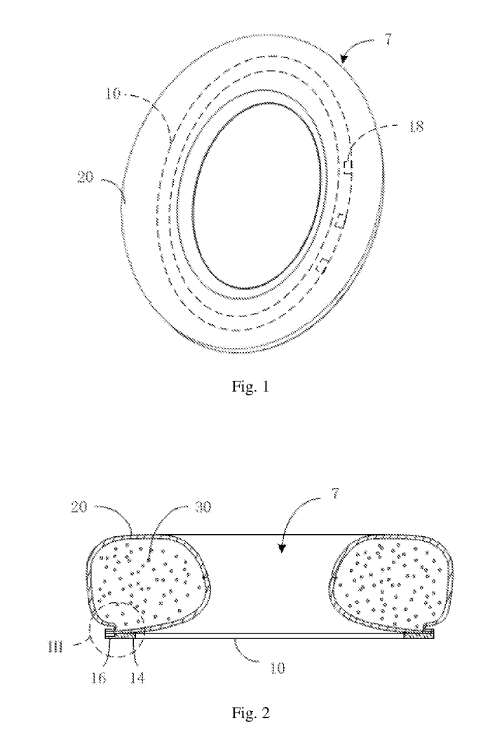

In combination with FIGS. 1 to 3, a first embodiment of the present disclosure provides an ear muff 7. The ear muff 7 includes a gasket 10, a covering piece 20 and a soft cushion 30. The gasket 10 includes a mounting surface 12, and the mounting surface 12 has two opposite side edges 14 and 16, namely an inner-side edge 14 adjacent to a center of the gasket 10 and an outer-side edge 16 away from the center of the gasket 10. The gasket 10 further includes a plurality of recesses 18 provided at the outer-side edge 16, that is, the recesses 18 extend to an outer-side surface of the gasket 10. Each of the recesses 18 includes an inner surface 18a. In the present embodiment, the recess 18 is a groove not penetrating a lower surface of the gasket 10. The lower surface is opposite to the mounting surface 12. The covering piece 20 is fixed to the outer-side edge 16 providing the recesses 18 and does not contact with the inner surfaces 18a of the recesses 18. Specifically, in the present embodiment, the covering piece 20 is made of protein leather, man-made leather or the like, and includes two distal ends 22 and 24 opposite to each other. The two distal ends 22 and 24 overlap each other and are fixed to the outer-side edge 16 in a manner such as hot-pressing or sewing. The two distal ends 22 and 24 do not contact the inner surfaces 18a of the recesses 18. Thus, a part of the covering piece 20 fixed to the outer-side edge 16 forms a mounting portion, and a part thereof corresponding to the recess 18 forms a spacing portion. The soft cushion 30 may be made of sponge and covered in the covering piece 20.

In the above-mentioned structure according to the first embodiment of the present disclosure, as the covering piece 20 does not contact the inner surfaces 18a of the recesses 18 when fixes to the outer-side edge 16 of the gasket 10, portions of the distal ends 22 and 24 of the covering piece 20 corresponding to positions of the recesses 18 are not fixed to the gasket 10, in which case air can get in and out of the covering piece 20 through the portions of the distal ends 22 and 24 unfixed to each other in a deformation process of the soft cushion 30, so as to facilitate the deformation of the soft cushion 30. With the above-mentioned structure provided in the present embodiment, it is not required to perforate the covering piece 20, thereby reducing a rejection rate of the covering piece 20.

It could be understood that, the recess 18 may also be a notch provided at the outer-side edge 16 and penetrating the lower surface of the gasket 10 in other embodiments, as illustrated in FIG. 4, in which case the above purpose of facilitating the deformation of the soft cushion 30 can also be achieved. In addition, it could be understood that the recesses 18 may also be provided at the inner-side edge 14 in other embodiments, and the covering piece 20 is fixed to the inner-side edge 14 and does not contact the inner surfaces 18a of the recesses 18 as well.

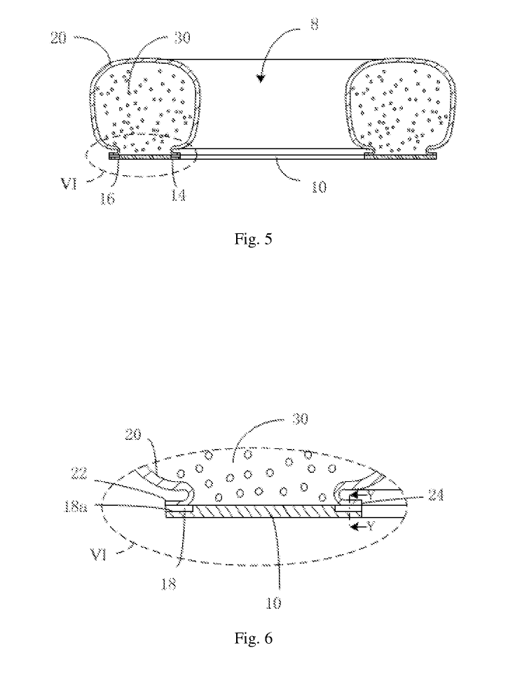

In combination with FIGS. 5 to 6, which are schematic views of an ear muff 8 according to a second embodiment of the present disclosure, the ear muff 8 differs from the ear muff 7 according to the first embodiment in that the inner-side edge 14 and the outer-side edge 16 of the mounting surface of the gasket 10 both provide with the recesses 18, and the distal ends 22 and 24 of the covering piece 20 are fixed to the inner-side edge 14 and the outer-side edge 16 respectively, in which similarly, the distal ends 22 and 24 do not contact the inner surfaces 18a of the recesses 18 as well. In the second embodiment, the ear muff 8 may be provided with more recesses 18 than the ear muff 7 in the first embodiment, such that it is more beneficial for the deformation of the soft cushion 30. In addition, the distal ends 22 and 24 directly adjoin the recesses 18, instead of overlapping each other in positions corresponding to the recesses 18, thus further facilitating the deformation of the soft cushion 30.

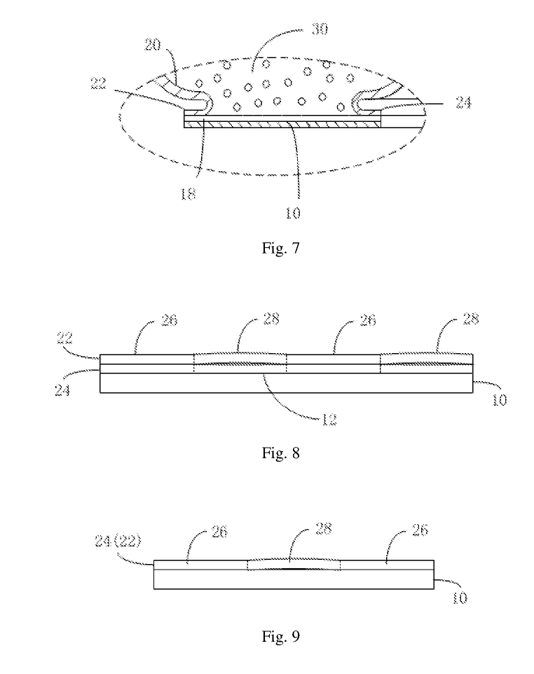

Similarly, the recess 18 may not only be the groove not penetrating the lower surface of the gasket 10 at the outer-side edge 16 illustrated in FIG. 5 and FIG. 6, but also be the notch penetrating the lower surface of the gasket 10 at the outer-side edge 16 thereof. In addition, the recess 18 is preferably configured as the groove not penetrating the lower surface of the gasket 10 and the groove extends from the outer-side edge 16 to the inner-side edge 14. In this structure, a part of the recess 18 located at a middle area in FIG. 7 more adjoins the soft cushion 30, thus facilitating the flow of more air.

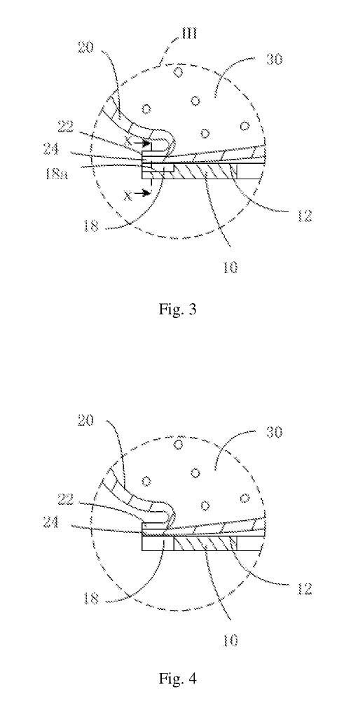

In combination with FIGS. 8 and 3, which are side views of an ear muff according to a third embodiment of the present disclosure, the ear muff differs from the ear muff 7 according to the first embodiment in that the gasket 10 is not provided with the above recesses 18. In order to realize the same purpose as above, in the production process, the two distal ends 22 and 24 of the covering piece 20 are fixed to the gasket 10 discontinuously, instead of being fixed to the gasket 10 entirely. Specifically, the covering piece 20 includes a plurality of mounting portions 26 and a plurality of spacing portions 28. Each mounting portion 26 is arranged alternately with the spacing portion 28. The plurality of mounting portions 26 is fixed to either of the outer-side edge 16 and the inner-side edge 14 (for example the outer-side edge 16 as illustrated in FIG. 2), and the plurality of spacing portions 28 is separable from the side edge. Thus, the air can get in and out of the covering piece through the spacing portions 28 separable from the gasket 10. It should be pointed out that a dashed line between the mounting portion 26 and the spacing portion 28 adjacent to each other in FIG. 8 are only intended for illustration.

In the embodiment illustrated in FIG. 8, the covering piece 20 includes two distal ends 22 and 24 opposite to and overlapping each other, the plurality of mounting portions 26 and the plurality of spacing portions 28 are located at the two overlapped distal ends 22 and 24, and the mounting portions 26 are fixed to the outer-side edge away from the center of the gasket 10. However, in combination with FIGS. 6 and 9, it could be understood that the covering piece 20 may include two distal ends 22 and 24 opposite to and spaced apart from each other, the distal ends 22 and 24 are each provided with the plurality of mounting portions 26 and the plurality of spacing portions 28, and the mounting portions 26 of the respective distal ends are fixed to the outer-side edge 16 and the inner-side edge 14 respectively. That is, the mounting portions 26 of the distal end 22 are fixed to the outer-side edge 16 and the mounting portions 26 of the distal end 24 are fixed to the inner-side edge 14, as illustrated in FIG. 5 and FIG. 6.

In the specification, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

In the present specification, unless specified or limited otherwise, the terms “mounted,” “connected,” “couple” and the like are used broadly, and may be, for example, fixed connections, detachable connections, or integral connections; may also be direct connections or indirect connections via intervening structures; may also be inner communications or interaction relationship of two elements, which can be understood by those skilled in the art according to specific situations.

The descriptions above are only preferable embodiments of the present disclosure and are not used to limit the present disclosure. Any modifications, equal alternatives, and improvements made within the spirit and principle of the present disclosure should be included in the protection scope of the present disclosure.

1. An ear muff, comprising:
a gasket comprising a mounting surface with two side edges opposite to each other;
a covering piece comprising a plurality of mounting portions and a plurality of spacing portions, each mounting portion and each spacing portion being arranged alternatively, the plurality of mounting portions being fixed to any of the two side edges and the plurality of spacing portions being separable from the any of the two side edges fixing the plurality of mounting portions; and
a soft cushion covered in the covering piece.

2. The ear muff according to claim 1, wherein:
the gasket further comprises a plurality of recesses arranged at at least one of the two side edges, each recess comprises an inner surface;
the covering piece is fixed to the side edge providing the recesses and does not contact with the inner surfaces of the recesses, a part of the covering piece fixed to the side edge providing the recesses is configured as the mounting portion, and another part of the covering piece corresponding to the recess is configured as the spacing portion.

3. The ear muff according to claim 2, wherein:
the recesses are provided in an outer-side edge of the mounting surface away from a center of the gasket;
the covering piece comprises two opposite distal ends, and the two distal ends are both fixed to the outer-side edge.

4. The ear muff according to claim 3, wherein the recess is configured as a groove not penetrating the gasket or a notch penetrating the gasket.

5. The ear muff according to claim 2, wherein:
the recesses are provided at both an outer-side edge of the mounting surface away from a center of the gasket and an inner-side edge of the mounting surface adjacent to the center of the gasket;
the covering piece comprises two opposite distal ends, and the two distal ends are fixed to the inner-side edge and the outer-side edge respectively.

6. (canceled)

7. The ear muff according to claim 5, wherein the recess is configured as a groove not penetrating the gasket or a notch penetrating the gasket.

8. The ear muff according to claim 5, wherein the recess is configured as a groove not penetrating the gasket and extending from the outer-side edge to the inner-side edge.

9. The ear muff according to claim 1, wherein the covering piece comprises two distal ends opposite to and overlapping each other, the plurality of mounting portions and the plurality of spacing portions are located at the two overlapped distal ends, and the mounting portions are fixed to an outer-side edge of the mounting surface away from a center of the gasket.

10. The ear muff according to claim 1, wherein:
the two opposite side edges comprise an outer-side edge away from a center of the gasket and an inner-side edge adjacent to the center of the gasket; 1
the covering piece comprises two distal ends opposite to and spaced apart from each other, each of the two distal ends is provided with the plurality of mounting portions and the plurality of spacing portions, and the mounting portions of one of the two distal ends are fixed to the outer-side edge and the mounting portions of the other one of the two distal ends are fixed to the inner-side edge.
